(19) United States
(12) Patent Application Publication
(10) Pub. No.: US 2004/0240425 A1
(43) Pub. Date: Dec. 2, 2004

(54) Wireless gateway subject to the IEEE 802.11b protocol

(76) Inventors: HuaLong Chen, Shenzhen (CN); Mingwu Jiang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/830,198

(22) Filed: Apr. 21, 2004

(30) Foreign Application Priority Data
May 28, 2003 (TW) 92209837

(51) Int. Cl. H04L 12/56

(52) U.S. Cl. 370/349

(57) ABSTRACT

A wireless gateway (10) subject to the IEEE 802.11b protocol includes a central processing unit (CPU) (101) for restructuring and transmitting Internet protocol (IP) packets, at least one synchronous dynamic random access memory (SDRAM) (102) connected with the CPU for exchanging data with the CPU and for storing application programs, a flash memory (103) connected with the CPU for storing driving programs and related configurations, a crystal oscillator (104) connected with the CPU for providing clock signals for the CPU, an Ethernet transceiver (106) connected with the CPU for transmitting and receiving Ethernet frames, and at least one port connected with the CPU for connecting one or more computers and/or computer peripherals in a wireless manner.

### BACKGROUND OF THE INVENTION

1. Field of the Invention

The present invention relates to an electronic communication gateway, and more particularly to a wireless gateway adapted to a small office home office (SOHO) wireless local area network (WLAN).

2. Description of Prior Art

A wireless gateway is an important component of the SOHO WLAN. A user can employ different computer peripherals located anywhere in the SOHO through the wireless gateway. Current transmission technologies for the wireless gateway comprise the Bluetooth protocol and The Institute of Electrical and Electronics Engineers (IEEE) 802.11b protocol.

China. Pat. No. 02222141.7 issued on Jan. 1, 2003 discloses a Bluetooth gateway based on transfer control protocol/Internet protocol (TCP/IP). FIG. 3 is a schematic diagram of circuit infrastructure of the Bluetooth gateway. The Bluetooth gateway comprises an antenna U1 for transmitting and receiving signals, a Bluetooth module U2 connected with the antenna U1, a central processing unit (CPU) U4, a converting circuit U3 for connecting the Bluetooth module U2 with the CPU U4, a network card chip U5 having a wire network interface U8, an address flip-latch U6, and a random-access memory (RAM) U7. The network card chip U5, the address flip-latch U6 and the RAM U7 communicate with the CPU U4 by way of a data bus A and an address bus B.

The maximum data transmission rate of the Bluetooth gateway is only 1 Mbit/s and the communication radius thereof is approximately 10 meters. In contrast, various wireless systems subject to the IEEE 802.11b protocol can have a maximum data transmission rate of 11 Mbit/s, and can automatically adjust the data transmission rate to be 5.5 Mbit/s, 2 Mbit/s or 1 Mbit/s according to different requirements. In addition, the maximum communication distance of wireless systems subject to the IEEE 802.11b protocol is up to 100 meters. Compared with the characteristics exhibited by wireless systems subject to the IEEE 802.11b protocol, the Bluetooth gateway is lacking in capacity and versatility.

### SUMMARY OF THE INVENTION

Accordingly, a primary object of the present invention is to provide a wireless gateway subject to the IEEE 802.11b protocol.

In order to fulfill the above-mentioned primary object, the present invention provides a wireless gateway subject to the IEEE 802.11b protocol. The wireless gateway comprises a central processing unit (CPU) for restructuring and transmitting Internet protocol (IP) packets, at least one synchronous dynamic random access memory (SDRAM) connected with the CPU for exchanging data with the CPU and storing application programs, a flash memory connected with the CPU for storing driving programs and related configurations, a crystal oscillator connected with the CPU for providing clock signals for the CPU, an Ethernet transceiver connected with the CPU for transmitting and receiving Ethernet frames, and at least one port connected with the CPU for connecting one or more computers and/or computer peripherals in a wireless manner.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of an application environment of a wireless gateway subject to the IEEE 802.11b protocol according to the present invention;

FIG. 2 is a schematic diagram of hardware infrastructure of the wireless gateway subject to the IEEE 802.11b protocol according to the present invention; and

FIG. 3 is a schematic diagram of circuit infrastructure of a conventional Bluetooth gateway.

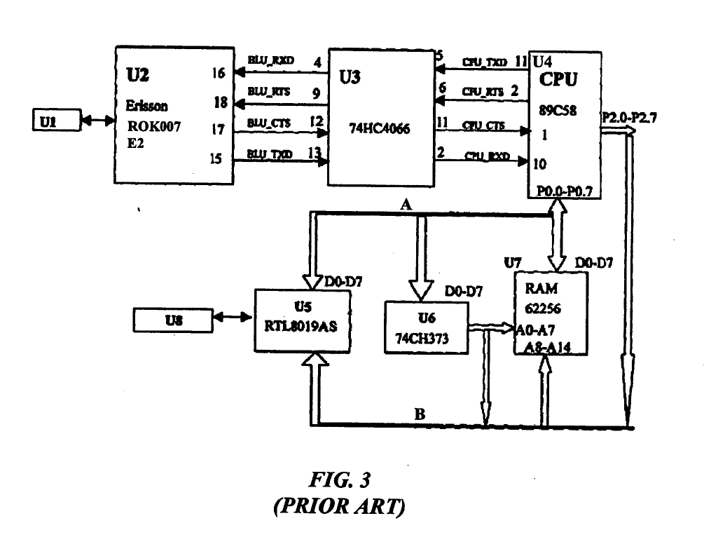

### DETAILED DESCRIPTION OF THE INVENTION

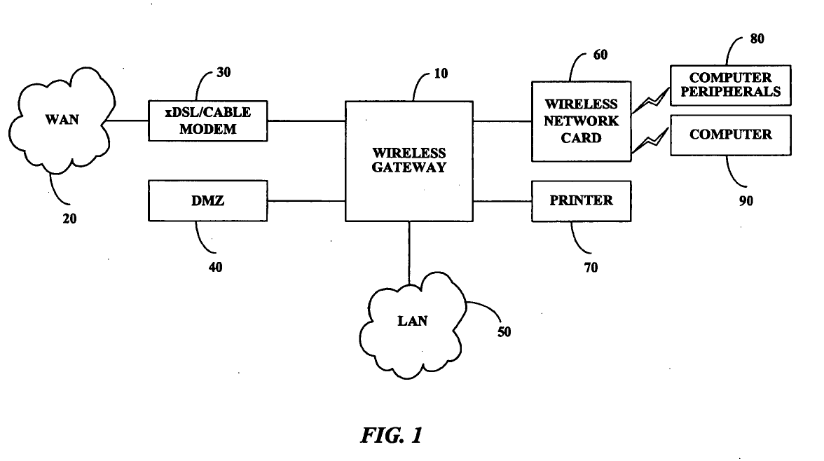

FIG. 1 is a schematic diagram of an application environment of a wireless gateway 10 subject to the IEEE 802.11b protocol according to the present invention. The wireless gateway 10 is coupled to a wide area network (WAN) 20 through an x digital subscriber line (xDSL)/cable modem 30, and is connected to a demilitarized zone (DMZ) 40 and a local area network (LAN) 50 via Ethernet ports (not shown). The wireless gateway 10 is coupled to a computer 90 and to computer peripherals 80 by using a wireless network card 60 in a wireless manner. In the embodiment described herein, the computer peripherals 80 are assumed to include a digital camera. A printer 70 is connected to the wireless gateway 10 via a universal serial bus (USB) interface (not shown). A user accesses the WAN 20, the DMZ 40, the LAN 50 and the printer 70 by employing the computer 90 through the wireless gateway 10.

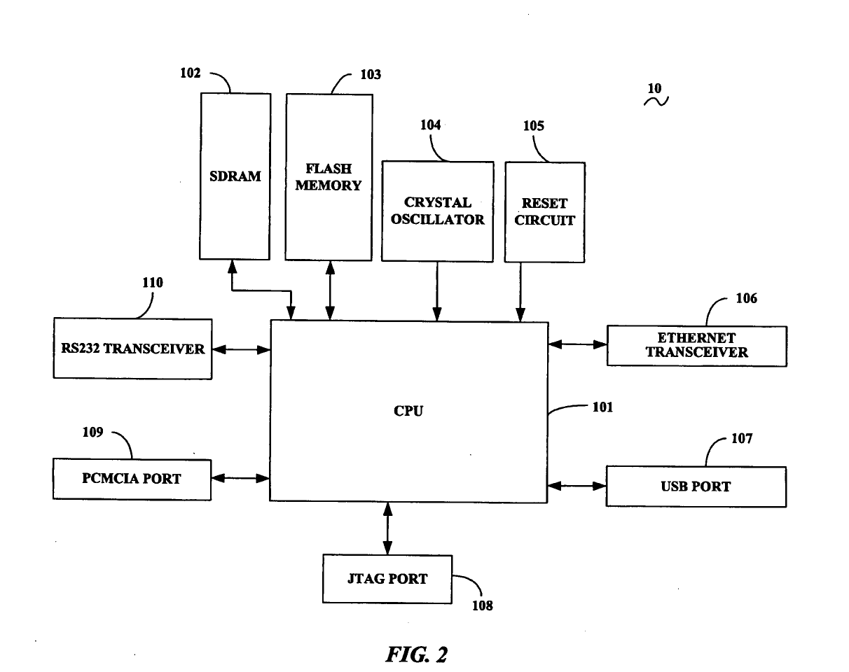

FIG. 2 is a schematic diagram of hardware infrastructure of the wireless gateway 10. The wireless gateway 10 comprises a central processing unit (CPU) 101 for restructuring and transmitting Internet protocol (IP) packets, two synchronous dynamic random access memories (SDRAMs) 102 for exchanging data with the CPU 101 and for storing application programs, a flash memory 103 for storing driving programs and related configurations, a crystal oscillator 104 for providing clock signals of 20 MHz for the CPU 101, a reset circuit 105 for resetting a clock of the CPU 101, an Ethernet transceiver 106 for transmitting and receiving Ethernet frames, a USB port 107 for connecting one or more computers 90 or computer peripherals 80 that have USB interfaces, a joint test action group (JTAG) port 108 for testing the CPU 101, a personal computer memory card international association (PCMCIA) port 109 for connecting the wireless network card 60 that has a PCMCIA interface, and an RS232 transceiver 110.

The CPU 101 is a kernel component of the wireless gateway 10, and is connected with the SDRAMs 102, the flash memory 103, the crystal oscillator 104, the reset circuit 105, the Ethernet transceiver 106, the USB port 107, the JTAG port 108, the PCMCIA port 109 and the RS232 transceiver 110. Each of said SDRAMs 102 has a capacity of 32M bytes, and the flash memory 103 has a capacity of 8M bytes. The Ethernet transceiver 106 comprises six 10/100 Ethernet ports. Four of said Ethernet ports are used for communicating with one or more LANs 50, and the other two are configured for connecting to the WAN 20 and the DMZ 40 each in one-to-one correspondence. The PCMCIA port 109 communicates with the computer 90 or the digital camera by way of the wireless network card 60 in a wireless manner. In the preferred embodiment of the present invention, the CPU 101 is implemented by an SD9148 chip produced by Silicon Data Company, and the Ethernet transceiver 106 is implemented by an RTL8208 chip produced by Realtek Company. In an alternative embodiment of the present invention, the wireless network card 60 is connected to the USB port 107 if the wireless network card 60 has a USB interface. In such case, the USB port 107 communicates with the computer 90 or the digital camera by way of the wireless network card 60 in a wireless manner.

While preferred embodiments of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A wireless gateway subject to the Institute of Electrical and Electronics Engineers (IEEE) 802.11b protocol, the wireless gateway comprising:
a central processing unit (CPU) for restructuring and transmitting Internet protocol (IP) packets;
at least one synchronous dynamic random access memory (SDRAM) connected with the CPU for exchanging data with the CPU, and for storing application programs;
a flash memory connected with the CPU for storing driving programs and related configurations;
a crystal oscillator connected with the CPU for providing clock signals for the CPU;
an Ethernet transceiver connected with the CPU for transmitting and receiving Ethernet frames; and
at least one port connected with the CPU for connecting one or more computers and/or computer peripherals in a wireless manner.

2. The wireless gateway as claimed in claim 1, further comprising a reset circuit for resetting a clock of the CPU.

3. The wireless gateway as claimed in claim 1, further comprising a joint test action group (JTAG) port for testing the CPU.

4. The wireless gateway as claimed in claim 1, further comprising an RS232 transceiver connected with the CPU.

5. The wireless gateway as claimed in claim 1, wherein the crystal oscillator provides clock signals of 20 MHz for the CPU.

6. The wireless gateway as claimed in claim 1, wherein the Ethernet transceiver comprises one or more Ethernet ports for communicating with local area networks (LANs) and wide area networks (WANs) each in one-to-one correspondence.

7. The wireless gateway as claimed in claim 1, wherein said port is a universal serial bus (USB) port.

8. The wireless gateway as claimed in claim 7, wherein the USB port is connected with the computers and/or the computer peripherals by using a wireless network card that comprises a USB interface.

9. The wireless gateway as claimed in claim 1, wherein said port is a personal computer memory card international association (PCMCIA) port.

10. The wireless gateway as claimed in claim 9, wherein the PCMCIA port is connected with the computers and/or the computer peripherals by using a wireless network card that comprises a PCMCIA interface.

11. A method of making a wireless gateway subject to the Institute of Electrical and Electronics Engineers (IEEE) 802.11b protocol, comprising steps of:
providing a central processing unit (CPU) for restructuring and transmitting Internet protocol (IP) packets;
providing at least one synchronous dynamic random access memory (SDRAM) connected with the CPU for exchanging data with the CPU, and for storing application programs;
providing a flash memory connected with the CPU for storing driving programs and related configurations;
providing a crystal oscillator connected with the CPU for providing clock signals for the CPU;
providing an Ethernet transceiver connected with the CPU for transmitting and receiving Ethernet frames; and
providing at least one port connected with the CPU for connecting one or more computers and/or computer peripherals in a wireless manner.
